(19) United States
(12) Patent Application Publication
(10) Pub. No.: US 2026/0054711 A1
(43) Pub. Date: Feb. 26, 2026

(54) METHOD FOR IDENTIFYING TEMPERATURE CHANGES, CAUSED BY A DEFECT, AT WHEEL ENDS OF A VEHICLE, EVALUATION UNIT AND VEHICLE

(71) Applicant: ZF CV Systems Global GmbH, Bern (CH)

(72) Inventors: Ruppert Kamping, Hannover (DE); Gerd Roters, Wunstorf (DE)

(21) Appl. No.: 19/377,695

(22) Filed: Nov. 3, 2025

Related U.S. Application Data
(63) Continuation of application No. PCT/EP2024/060280, filed on Apr. 16, 2024.

(30) Foreign Application Priority Data
May 2, 2023 (DE) 10 2023 111 259.7

(51) Int. Cl. B60T 17/22; G01K 1/02; G01K 3/00; G01M 13/04; G07C 5/04

(52) U.S. Cl. CPC B60T 17/22; G01K 1/026; G01K 3/005; G01M 13/04; G07C 5/04; B60T 2210/30; B60T 2220/04; B60T 2250/04

(57) ABSTRACT

A method is for identifying fault-induced temperature changes at wheel ends of a vehicle. At least two of the wheel ends have a wheel speed sensor having a temperature sensor configured to measure around its position a sensor temperature in a sensing region. The method includes: retrieving a first sensor temperature measured by a first temperature sensor at a first wheel end; and retrieving a second sensor temperature measured by a second temperature sensor at a second wheel end; determining a temperature deviation on the basis of the first sensor temperature and the second sensor temperature; comparing the temperature deviation with a deviation limit value; and outputting a notification when the deviation limit value is exceeded, which notification includes that a temperature change induced by a fault has been detected at least at one of the wheel ends that have a wheel speed sensor having a temperature sensor.

### CROSS-REFERENCE TO RELATED APPLICATIONS

This application is a continuation application of international patent application PCT/EP2024/060280, filed Apr. 16, 2024, designating the United States and claiming priority from German application 10 2023 111 259.7, filed May 2, 2023, and the entire content of both applications is incorporated herein by reference.

### TECHNICAL FIELD

The present disclosure relates to a method for identifying temperature changes at wheel ends of a vehicle, and to an evaluation unit and a vehicle for implementing the method.

### BACKGROUND

What are known as wheel ends or wheel-end assemblies of a vehicle have numerous safety-related components, for instance component parts of a braking system, in particular a brake caliper, a mounting flange for mounting a vehicle wheel, bearings, sensors or the like. The prevailing temperature at a wheel end therefore constitutes a significant input variable for self-diagnosis by the vehicle. For example, a raised temperature can indicate excessive stress on the brake. In this regard, a method is known from the prior art, for example from EP 1 564 431 A1, in which a temperature sensor is arranged on a non-rotating brake component, for instance a brake pad, in order to obtain thereby temperature information about the temperature of a brake disk.

DE 10 2019 004 963 A1 and GB 2 557 195 A likewise describe separate temperature sensors. In addition, U.S. Pat. No. 7,883,159 B2 describes estimating the temperature or temperature change on the basis of the energy applied by friction during braking by using speeds from a wheel speed sensor at the wheel end.

### SUMMARY

It is an object of the present disclosure to provide an alternative method for identifying fault-induced temperature changes at wheel ends of a vehicle, and an evaluation unit and a vehicle, which is configured to implement the method.

This object is achieved according to the disclosure by various embodiments of the disclosure including a method, an evaluation unit, and a vehicle.

A method according to the disclosure is for identifying fault-induced temperature changes, in particular fault-induced temperature rises, at wheel ends (wheel-end assemblies) of a vehicle, preferably of a commercial vehicle, wherein at each wheel end is rotatably mounted a wheel, and at least two of the wheel ends also each have a wheel speed sensor, preferably an actively driven wheel speed sensor, for measuring a wheel speed of the associated wheel, wherein each wheel speed sensor has a temperature sensor, that is, as an integral component part of the wheel speed sensor, wherein the temperature sensor is configured to measure and output a sensor temperature in a sensing region, which encompasses at least the wheel speed sensor concerned.

A wheel end or a wheel-end assembly of a vehicle is preferably formed by the fixed, that is, not co-rotating, outer end of a vehicle axle, wherein the vehicle axle can also exist merely virtually, as in the case of an independent suspension. Thus, a wheel end constitutes the region to which is attached in an outer direction the rotating wheel mounted at the wheel end. Hence a two-axle vehicle has four wheel ends.

The aforementioned wheel speed sensor must be arranged at the wheel end such that it can interact with the rotating wheel. Preferably, a magnet wheel fitted on the rotating wheel generates in the associated wheel speed sensor an alternating magnetic field, which is evaluated by the wheel speed sensor in order to deduce the wheel speed. The wheel speed sensor has a temperature sensor, for instance in order to adjust the sensitivity to the alternating magnetic field generated by the magnet wheel, because this sensitivity is temperature dependent.

It has been recognized according to the disclosure that as a result of the arrangement of the wheel speed sensor in the region of the wheel end, it is possible via the temperature sensor integrated in the wheel speed sensor to gather indirectly also information about the temperature or the temperature change in the region of the wheel end concerned. With suitable evaluation, this allows conclusions to be drawn about a fault in the region of the wheel end if the fault is a friction-inducing fault leading to a temperature rise in the surroundings that also occurs in the sensing region of the temperature sensor concerned and can hence be detected.

Thus, if there is sufficient heat transfer from the surroundings of the wheel end to the temperature sensor integrated in the wheel speed sensor, for example via the air or also by heat transfer on components of the wheel end, such friction-inducing faults can be ascertained without additional sensors, wherein this is achieved according to the disclosure by at least the following steps:
retrieving a first sensor temperature, which is measured by a first temperature sensor of a first wheel speed sensor at a first wheel end; and
retrieving a second sensor temperature, which is measured by a second temperature sensor of a second wheel speed sensor at a second wheel end;
determining a temperature deviation on the basis of the first sensor temperature and the second sensor temperature, for example by subtraction or forming a ratio;
comparing the temperature deviation with a deviation limit value; and
outputting a notification when the deviation limit value is exceeded and/or if the two sensor temperatures deviate too widely from each other, which notification includes that a fault-induced temperature change, in particular temperature rise, in particular induced by a friction-inducing fault, has been detected at least at one of the wheel ends that have a wheel speed sensor having a temperature sensor, that is, at the first wheel end having the first wheel or at the at least second wheel end having the second wheel.

According to the disclosure is also provided an evaluation unit and a vehicle for implementing the method.

Hence relative temperature differences between two wheel ends are evaluated that do not normally occur, which is taken into account by the deviation limit value. The deviation limit value is consequently selected such that the notification is output only when there is an unexpected temperature change between wheels, for instance because of a fault such as bearing damage or an overheating or overheated service brake. Since the temperature change that such a fault produces at the temperature sensor depends on the type of the fault and also on the position of the associated wheel speed sensor, or of the temperature sensor integrated therein, at the wheel end, the deviation limit value should preferably also be adjusted according to the position of the temperature sensor and also should be set according to the fault.

Thus, it must be established, for example, what temperature change would arise at the integrated temperature sensor, for instance at the assembled wheel end, were the fault to occur during driving given a certain ambient temperature. This can be ascertained by suitable tests or simulations, from which is then found the temperature change, and hence the deviation limit value, at and above which it makes sense to output a notification. Thus if a service brake that is overheating (or overheated) in previous tests through deliberate braking causes at an assembled wheel end a temperature change of between 80° C. and 100° C. at the associated temperature sensor, the deviation limit value can be set at, for example, 60° C. (given an ambient temperature of 20° C.).

This temperature value can be adopted because the temperature response during test braking of this kind is comparable to an overheating or overheated brake. If during subsequent driving, intrinsic differences arise in the temperature measurement between two temperature sensors (without a notification of a hot-running unit), the deviation limit value can also be suitably adjusted adaptively via a learning algorithm.

A similar procedure can take place for bearing damage, which can be simulated, for example, in order to ascertain the temperature change at the associated temperature sensor, and hence the deviation limit value, for the particular position of the temperature sensor and for this fault.

In order to rule out wheel-specific temperature changes that are not attributable to a fault, it can be provided that the method is carried out and/or the notification is output only when, within a specified time period before retrieving the first sensor temperature and the second sensor temperature, no (manual or automatic) braking request is present that has resulted in actuation of the particular service brake at the wheel end at which the sensor temperature concerned has been measured.

If, in the event of a braking request, brake actuations occur for example that are different between sides, for instance under μ-split conditions or braking while turning or the like, the service brakes can also be at different temperatures between sides, which is then measured by the relevant temperature sensor in the wheel speed sensor and might lead to a notification in the evaluation. To avoid incorrectly inferring a fault in this case, the evaluation according to the disclosure (or the output of the notification) only takes place when the specified time period has elapsed after a (manual or automatic) braking request.

The time period should be chosen such that temperature effects from a braking request that has been made do not falsify the method according to the disclosure. This time period cannot be set as a blanket value because the temperature rise at the service brakes brought about during a braking request continues to have an effect after the braking request has ceased, depending on a series of influencing variables on the temperature sensor. Influencing variables are, for example, the duration of the previous braking request, the magnitude of the previous braking request, the configuration of the service brake and associated therewith the cooling of the brake disk, the positioning of the associated wheel speed sensor, or of the temperature sensor integrated therein, at the wheel end, the ambient temperature, the vehicle speed (airflow), et cetera.

Thus the setting of the time period must take into account not only how fast the brake disk cools down again but also how “quickly” this can be detected by the temperature sensor. The time period can be preset after assembly of the wheel end initially on the basis of configuration parameters, and be adapted systematically during driving depending on the existing braking request, for instance its length and magnitude. In addition, the preset time period can accordingly be adjusted adaptively by a learning algorithm during driving.

It can also be preferred that the notification when the deviation limit value is exceeded and/or if the two sensor temperatures deviate too widely from each other includes that a first service brake, which is arranged at the first wheel end, or a second service brake, which is assigned to the second wheel end, according to which associated sensor temperature is higher, is overheating or has overheated as a result of a fault (hot-running unit), preferably because the brake pad at the wheel end concerned is being pressed against the brake disk even though a braking request is not present. It is thereby possible to identify, for example, faults caused by residual pressure in the brake line or incorrect adjustment of the service brake if the deviation limit value is chosen suitably, as described above. These lead to the brake pad being pressed against the brake disk even though there is no braking request for this, resulting in increased friction and hence a temperature rise, which can also be detected via the temperature sensor of the wheel speed sensor. Since such a fault normally occurs in a specific wheel, this can be identified by the ascertaining of the relative temperature difference or the temperature deviation.

To facilitate this, the wheel speed sensor is preferably arranged at the wheel end in such a way that fault-induced heating occurring at the brake pad and/or at the brake disk results in a change in the sensor temperature of the associated temperature sensor of the associated wheel speed sensor. This means that a temperature rise at the brake disk and/or the brake pad can be detected at least indirectly by a temperature rise at the wheel speed sensor when the temperature sensor, as in the present case, is not located directly at the brake disk or at the brake pad. Heating of these can still be detected even in the distance-separated sensing region of the temperature sensor of the wheel speed sensor. The deviation limit value can be suitably adjusted according to the distance or positioning in order to make the measurement more sensitive.

It can also be preferred that the wheel end has a bearing, wherein an axle shaft connected to the associated wheel is rotatably mounted at the wheel end via the bearing, wherein the wheel speed sensor is arranged at the wheel end in such a way that fault-induced heating occurring at the bearing of the associated wheel end results in a change in the sensor temperature of the associated temperature sensor of the associated wheel speed sensor. This means that a temperature rise at the bearing can be detected at least indirectly by a temperature rise at the wheel speed sensor even when the temperature sensor is not located directly at the bearing. Excessive heating of the bearing, for instance in the event of bearing damage, can still be detected even in the distance-separated sensing region of the temperature sensor of the wheel speed sensor if the deviation limit value is suitably selected, as described above. The deviation limit value can be suitably adjusted according to the distance or positioning in order to make the measurement more sensitive.

It can preferably be provided in this case that the notification when the deviation limit value is exceeded or if the two sensor temperatures deviate too widely from each other includes that the bearing at the wheel end for which a higher sensor temperature has been ascertained is overheating or has overheated as a result of a fault. For the reasons stated above, this can also preferably take place in combination with there being, within a specified time period before retrieving the first sensor temperature and the second sensor temperature, no (manual or automatic) braking request present that has resulted in actuation of the particular service brake at the wheel end at which the sensor temperature concerned has been measured.

For example, it is thereby possible to identify a bearing damaged during operation that results in increased friction and hence a temperature rise, which can also be detected via the temperature sensor of the wheel speed sensor. Since such a fault normally occurs in a specific wheel, this can be identified by the ascertaining of the relative temperature difference or the temperature deviation.

In order to be able to ascertain a corresponding temperature deviation for which one of the described faults does not affect the temperature measurement of both temperature sensors simultaneously, it is preferred that the first wheel end under observation and the second wheel end under observation are arranged on different sides of the vehicle, for instance on the same vehicle axle of the vehicle. In this variant, the load on the wheel ends during normal driving is approximately the same, so the two sensor temperatures can be compared most easily. It is also possible, however, that the first wheel end under observation and the second wheel end under observation are arranged on the same side of the vehicle on different vehicle axles, and hence sensor temperatures from different vehicle axles are compared with each other. In order to include influences that are different for specific axles in this case, for instance resulting from the environment or loading or the like, the deviation limit value can be set differently accordingly, where these different influences can also be learned or adaptively adjusted during driving by a learning algorithm on the basis of observations.

In addition, it can also be provided in this case that the temperature deviation between a first mean value, which depends on the first sensor temperature, and a second mean value, which depends on the second sensor temperature, is formed, wherein:
the first mean value is formed from the first sensor temperature, which is measured at a first vehicle axle at the first wheel speed sensor by the first temperature sensor at the first wheel end, and from a further sensor temperature, which is likewise measured at the first vehicle axle at a further wheel speed sensor by its temperature sensor at a further wheel end, and
the second mean value is formed from the second sensor temperature, which is measured at a second vehicle axle at the second wheel speed sensor by the second temperature sensor at the second wheel end, and from a further sensor temperature, which is likewise measured at the second vehicle axle at a further wheel speed sensor by its temperature sensor at a further wheel end. This averaging can deliver more robust results when observations are across axles.

Depending on the driving situation and load on the wheels, different observations (between wheels or between axles) can be advantageous in order to be able to ascertain a meaningful temperature deviation.

In all the embodiments mentioned, a plausibility check can be performed in general by taking into account further sensor data or diagnostic states of the vehicle that are likewise affected by a fault.

For the evaluation in the evaluation unit can be provided that this is a component part of a brake control unit of a braking system of the vehicle. This means that the brake control unit can take into account directly a fault identified via the method. In addition, the brake control unit is normally in signal communication with the wheel speed sensors, and the corresponding measured values for the temperature are available in this unit. It is also possible, however, to provide a suitable connection between the evaluation unit and the brake control unit or directly to the individual wheel speed sensors.

### BRIEF DESCRIPTION OF DRAWINGS

The invention will now be described with reference to the drawings wherein:

FIG. 1 shows a schematic overview of a vehicle configured to implement the method according to the disclosure;

FIG. 2 shows a detailed view of a segment of FIG. 1; and,

FIG. 3 shows a flow diagram of the method according to the disclosure.

### DETAILED DESCRIPTION

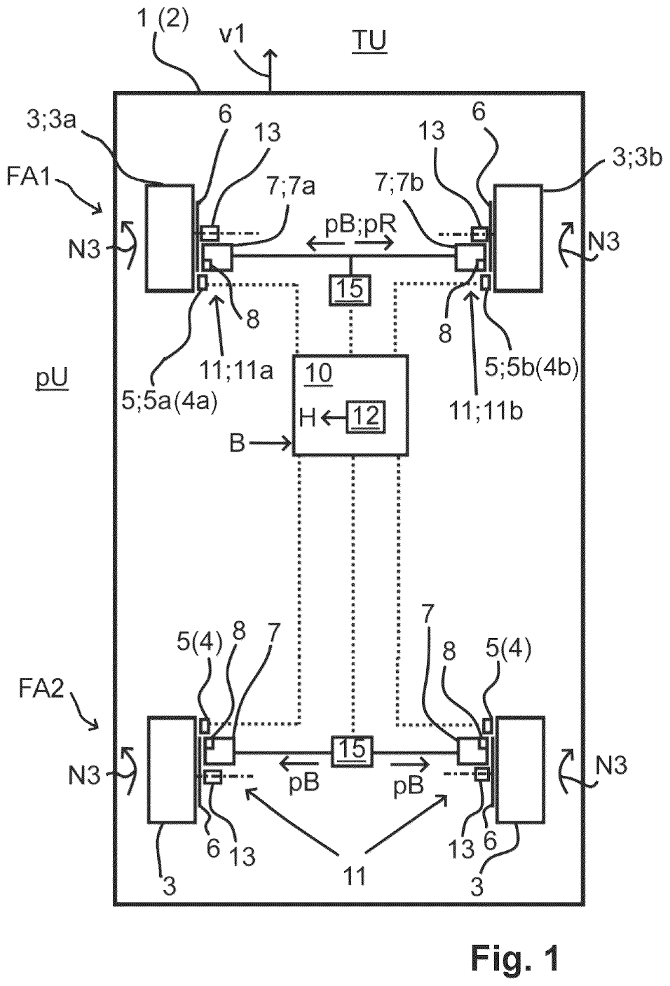

FIG. 1 shows a vehicle 1 having two vehicle axles FA; FA1, FA2 and a pneumatic or electro-pneumatic braking system 2, which can be controlled electrically via a brake control unit 10. For this purpose, the braking system 2 has service brakes 7, in particular disk brakes having brake disks 6, at the individual wheels 3 of the vehicle 1, which can be operated by actuating with a certain brake pressure pB in order to brake the vehicle 1. The brake pressure pB is generated pneumatically or electro-pneumatically (as represented in FIG. 1 by an axle modulator 15) according to a braking request B given manually or in an automated manner.

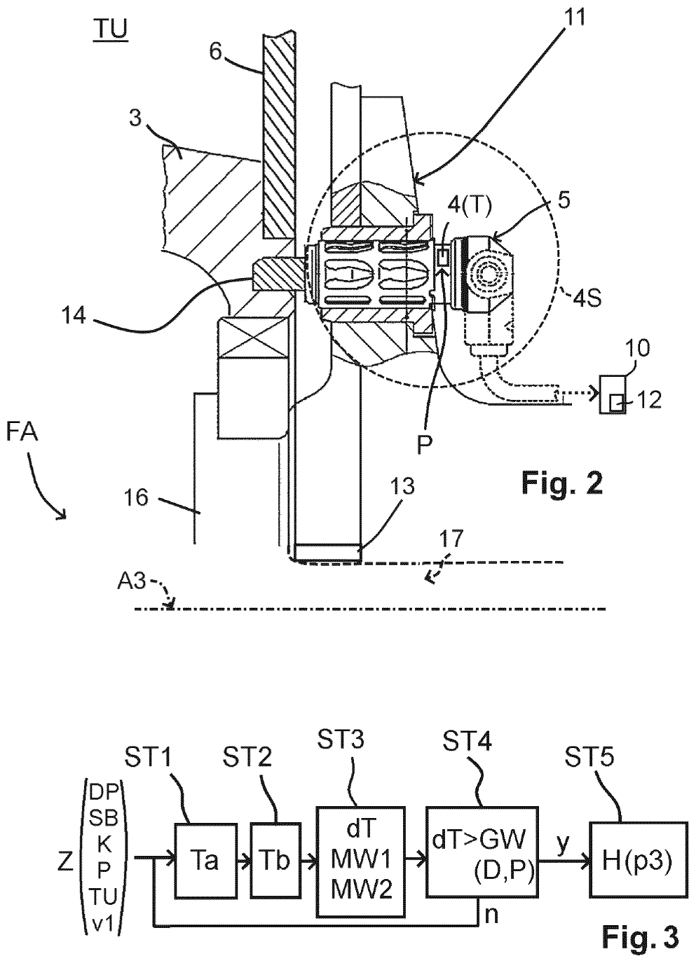

In addition, the vehicle 1 has wheel ends 11 or wheel-end assemblies, with each wheel 3 being associated with one such wheel end 11. As shown in FIG. 2, a wheel 3 is attached, for instance screwed, to the associated wheel end 11 via a mounting flange 16. The mounting flange 16 is connected to an axle shaft 17, as shown in FIG. 2 highly schematically, which in turn is rotatably mounted on a housing of the wheel end 11 via a bearing 13, so that the axle shaft 17 can rotate together with the wheel 3 attached thereto about a wheel axle A3. Part of the wheel end 11 is also a brake caliper (not presented in greater detail), which is likewise attached to the housing of the wheel end 11 and which has a brake pad 8 which presses against the brake disk 6 during braking.

Without a braking request B, the service brakes 7 are normally not operated or not actuated, that is, the brake pad 8 of the service brake 7 is not pressed against the brake disk 6, which is connected to the wheel 3 concerned, by the brake pressure pB (approximately ambient pressure pU) that is then acting in the brake pressure lines. If the service brakes 7 are incorrectly adjusted and/or if a residual pressure pR exists in the brake pressure lines that is higher than the ambient pressure pU, that is, pB=pR>pU, it can happen, however, that the brake pad 8 is pressed against the brake disk 6 even without a braking request B being present. As a result, the service brake 7 concerned overheats during operation of the vehicle 1, because constant frictional contact exists between the brake pad 7a and the brake disk 6.

In addition, the wheels 3 of the vehicle 1 are assigned wheel speed sensors 5 specifically for each wheel, via which a wheel speed N3 of the respective wheels 3 can be sensed. The wheel speed sensor 5 is likewise a component part of the wheel end 11 and attached to the housing of the wheel end 11 via a suitable mounting. The wheel speed sensors 5 can be operated actively, that is, they only output or generate a signal, in which the wheel speed N3 is encoded, once a supply voltage is applied.

Such wheel speed sensors 5 also have a temperature sensor 4, via which a sensor temperature T inside the wheel speed sensor 5 or within a certain sensing region 4S around the position P of the temperature sensor 4 can be measured in order to adjust, for example, a sensitivity of the wheel speed sensor 5 for operation. A magnet wheel 14 induces a magnetic field during an incremental magnetic measurement of the wheel speeds N3, and temperature-dependent effects can arise during this measurement.

For the embodiment shown in FIG. 1, it is thus possible to identify overall also unintentional temperature changes at the individual wheel ends 11. This is done by a combined or comparative observation of the sensor temperature T at different wheel ends 11, in FIG. 1 in particular at a first wheel end 11a and at a second wheel end 11b, which are associated with a first wheel 3a and a second wheel 3b of the front axle as the first vehicle axle FA1, and which have the necessary first and second wheel speed sensors 5a, 5b each having a temperature sensor 4. In principle, in FIG. 1 the further wheel ends 11 on the rear axle as the second vehicle axle FA2 can also have the wheel speed sensors 5 required to implement the method according to the disclosure.

It has been recognized according to the disclosure that the sensing region 4S of the temperature sensors 4 in the respective wheel speed sensors 5 are embodied such that it is thereby possible also to detect temperature changes that occur as a result of unwanted faults D in the region of the wheel end 11 concerned, for example caused by an overheated sensing region 7 or a faulty bearing 13. In the event of such faults D, increased friction results in particular in a local increase in the ambient temperature in the region of the wheel end 11, which, by a suitable wheel-specific temperature evaluation of the sensor temperature T in an evaluation unit 12 (as a component part of the brake control unit 10 as shown or as an external unit (not shown), which can communicate via suitable lines with the wheel speed sensors 5 in order to retrieve the sensor temperature T), can be identified as follows (see FIG. 3):

Initially, in a first step ST1, a first sensor temperature Ta is ascertained or retrieved, which is measured by a first temperature sensor 4a of a first wheel speed sensor 5a at a first wheel end 11a. Then, in a second step ST2, a second sensor temperature Tb is ascertained or retrieved, which is measured by a second temperature sensor 4b of a second wheel speed sensor 5b at a second wheel end 11b. The two wheel ends 11a, 11b need not necessarily be on the same vehicle axle FA (front axle (first vehicle axle FA1) or rear axle (second vehicle axle FA2)) or on the same side of the vehicle, because just a temperature deviation dT according to the first sensor temperature Ta and the second sensor temperature Tb at distance-separated positions in the vehicle 1 is relevant, which is ascertained in a third step ST3. A local temperature rise resulting from a wheel-specific fault D should not affect both temperature measurements simultaneously in the first and second steps ST1, ST2.

It is advantageous, however, if the two wheel ends 11a, 11b to be compared are located on the same vehicle axle FA, because then comparable loads result from the vehicle construction and also the other influences on the wheel ends 11a, 11b under observation are comparable. If, nonetheless, an observation between axles is intended, then the temperature deviation dT can be obtained by averaging as follows:

A first mean value MW1 is formed from the first sensor temperature Ta, which in this case is measured at the first vehicle axle FA1 (for example, front axle) at the first wheel speed sensor 5a by the first temperature sensor 4a at the first wheel end 11a, and a further sensor temperature T, which is likewise measured at the same first vehicle axle FA1 (for example, front axle) at a further wheel speed sensor 5 (on the other side of the vehicle) by its temperature sensor 4 at a further wheel end 11. The second mean value MW2 is formed similarly from the retrieved second sensor temperature Tb, which in this case, however, in contrast with the representation in FIG. 1, is measured at the second wheel speed sensor 5b, which in this case is arranged at the second vehicle axle FA2 (for example, rear axle), by the second temperature sensor 4b at the second wheel end 11b, and a further sensor temperature T, which is likewise measured at the second vehicle axle FA2 at a further wheel speed sensor 5 (on the other side of the vehicle) by its temperature sensor 4 at a further wheel end 11.

Subsequently, in a fourth step ST4, the temperature deviation dT is then compared with a deviation limit value GW, where the deviation limit value GW can be set according to the type of the fault D (hot-running unit, bearing damage) and the position P of the temperature sensor 4 concerned at the associated wheel end 11a, 11b. This takes into account, in addition to including the temperature fluctuations that would normally be expected between the individual wheel ends 11; 11a, 11b, how strongly a certain fault D affects the sensing region 4S of the temperature sensor 4 concerned. Furthermore, changes in the deviation limit value GW can arise during driving over a prolonged period of time, which can be adjusted adaptively, for example, by a learning algorithm.

If it is detected that the deviation limit value GW has been exceeded, that is, the sensor temperatures Ta, Tb deviate too widely from each other, a notification H is output in a fifth step ST5. For example, this then indicates that an unexpected temperature rise exists at the wheel end 11; 11a, 11b that has the higher of the two ascertained sensor temperatures T; Ta, Tb. It is assumed here that given too high a temperature deviation dT, it is not the lower of the two sensor temperatures T; Ta, Tb that is critical but the higher sensor temperature T; Ta, Tb.

Thus for the case in which an overheated brake disk 6 exists in a service brake 7 associated with the wheel 3 concerned, a corresponding temperature deviation dT can be detected if the friction-induced temperature rise can be detected at least in part also in the sensing region 4S of the temperature sensor 4 at this wheel 3. It must be taken into account here that within a specified time period Z no braking request B was present that has led to an intended application of the service brake 7 and hence automatically also to the production of heat. In the event of wheel-specific braking, this would otherwise likewise lead to a temperature deviation dT, which then however is intended and not attributable to a fault.

This time period Z cannot be set as a blanket value because the temperature rise at the service brakes 7 brought about during a braking request B continues to have an effect after the braking request B has ceased, depending on a series of influencing variables on the temperature sensor 4. Influencing variables are, for example, the duration of the previous braking request DB, the magnitude of the previous braking request SB, the configuration K of the service brake 7 and associated therewith the cooling of the brake disk 6, the position P of the associated wheel speed sensor 5, or of the temperature sensor 4 integrated therein, at the associated wheel end 11, the ambient temperature TU, the vehicle speed v1 (airflow), et cetera. Thus the time period must be adjusted according to the driving situation, where an adaptive adjustment by a learning algorithm is also possible here in the case of changes over time.

If, however, such a braking request B is not present in the previous time period Z nor currently, and if too high a temperature deviation dT was, or is, ascertained nonetheless, this can be attributed, inter alia, to a heated brake disk 6 as a result of an incorrect adjustment of the service brake 7 and/or as a result of a raised residual pressure pR. Thus a potentially overheated service brake 7 at the wheel end 11 that has the currently higher ascertained sensor temperature T can thereby be inferred indirectly via the temperature sensor 4.

A further cause of too high a temperature deviation dT, preferably without the previous and current existence of a braking request 8, can be a fault in the bearing 13 in the wheel end 11 concerned, because again then the friction-induced temperature rise can be detected directly at least in part also in the sensing region 4S of the temperature sensor 4 at this wheel 3.

In order to be able to distinguish the current cause, the deviation limit values GW can be set according to the fault D, for example in prior tests or simulations.

It is understood that the foregoing description is that of the preferred embodiments of the invention and that various changes and modifications may be made thereto without departing from the spirit and scope of the invention as defined in the appended claims.

### LIST OF REFERENCES (PART OF THE DESCRIPTION)

1 vehicle
2 braking system
3 wheels of the vehicle 1
3a first wheel
3b second wheel
4 temperature sensor
4a first temperature sensor
4b second temperature sensor
4S sensing range
5 wheel speed sensor
5a first wheel speed sensor
5b second wheel speed sensor
6 brake disk
7 service brake
7a first service brake
7b second service brake
8 brake pad
10 brake control unit
11 wheel end
11a first wheel end
11b second wheel end
12 evaluation unit
13 bearing
14 magnet wheel
15 axle modulator
16 mounting flange
17 axle shaft
A3 wheel axle
B braking request
D fault
DB duration of the braking request B
dT temperature deviation
FA vehicle axle
FA1 first vehicle axle
FA2 second vehicle axle
GW deviation limit value
H notification
K configuration of the service brake 7
MW1 first mean value
MW2 second mean value
N3 wheel speed
P position of the temperature sensor 4
p3 tire pressure value
pB braking pressure
pR residual pressure
pU ambient pressure
SB magnitude of the braking request B
T sensor temperature
Ta first sensor temperature
Tb second sensor temperature
TU ambient temperature
v1 vehicle speed
Z time period
ST1, ST2, ST3, ST4, ST5 steps of the method

1. A method for identifying fault-induced temperature changes at a plurality of wheel ends of a vehicle including a first wheel end and a second wheel end, wherein at each of the plurality of wheel ends a wheel is rotatably mounted, the first wheel end has a first wheel speed sensor for measuring a wheel speed of a first wheel and the second wheel end has a second wheel speed sensor for measuring a wheel speed of the first wheel, the first wheel speed sensor has a first temperature sensor configured to measure, around a position of the first temperature sensor, and to output a first sensor temperature in a first sensing region, which encompasses at least the first wheel speed sensor, the second wheel speed sensor has a second temperature sensor configured to measure, around a position of the second temperature sensor, and to output a second sensor temperature in a second sensing region, which encompasses at least the second wheel speed sensor, the method comprising:
retrieving the first sensor temperature measured by the first temperature sensor of the first wheel speed sensor at the first wheel end;
retrieving the second sensor temperature measured by the second temperature sensor of the second wheel speed sensor at the second wheel end;
determining a temperature deviation on a basis of the first sensor temperature and the second sensor temperature;
comparing the temperature deviation with a deviation limit value; and,
outputting a notification if at least one of the deviation limit value is exceeded and the first sensor temperature and the second sensor temperature deviate too widely from each other, wherein the notification includes that a temperature change induced by a fault has been detected at least at one of the first wheel end and the second wheel end.

2. The method of claim 1, wherein the notification includes that a friction-inducing fault that results in a temperature change in the sensing region of the associated temperature sensor has been detected at the wheel end that has the currently higher sensor temperature.

3. The method of claim 1, wherein a specific deviation limit value is set for each fault.

4. The method of claim 1, wherein each of the deviation limit values is set according to the position of the associated temperature sensor at least one of: at the associated wheel end and inside the associated wheel speed sensor.

5. The method of claim 1, wherein the deviation limit value is adjusted adaptively during driving.

6. The method of claim 1, wherein at each of the plurality of wheel ends is arranged a brake pad of a service brake, which, in order to brake an associated wheel, is configured to be pressed against a brake disk connected to the associated wheel, when a braking request is present.

7. The method of claim 6, wherein the notification at least one of when the deviation limit value is exceeded and if the two sensor temperatures deviate too widely from each other includes that a first service brake, which is assigned to the first wheel end, or a second service brake, which is assigned to the second wheel end, according to which associated sensor temperature is higher, is overheating or has overheated as a result of a fault.

8. The method of claim 7, wherein the fault is caused by the brake pad at the respective wheel end being pressed against the brake disk even though the braking request is not present.

9. The method of claim 6, wherein the wheel speed sensors are arranged at the respective wheel ends such that fault-induced heating occurring at least at one of the brake pad and the brake disk results in a change in the sensor temperature of the associated temperature sensor of the associated wheel speed sensor.

10. The method of claim 6, wherein at least one of the method is only carried out and the notification is only output when, within a specified time period before retrieving the first sensor temperature and the second sensor temperature, no braking request is present that has resulted in actuation of the particular service brake at the wheel end at which the sensor temperature concerned has been measured.

11. The method of claim 10, wherein the time period is specified according to at least one influencing variable, which is selected from a group including:
duration of the previous braking request, magnitude of the previous braking request, configuration of the particular service brake, position of the particular temperature sensor at the associated wheel end and/or inside the associated wheel speed sensor, ambient temperature, and vehicle speed.

12. The method of claim 1, wherein each of the plurality of wheel ends has a bearing, wherein an axle shaft connected to the associated wheel is rotatably mounted at the wheel end via the bearing; the wheel speed sensor is arranged at the wheel end such that fault-induced heating occurring at the bearing of the associated wheel end results in a change in the sensor temperature of the associated temperature sensor of the associated wheel speed sensor.

13. The method of claim 11, wherein the notification at least one of when the deviation limit value is exceeded and if the two sensor temperatures deviate too widely from each other includes that the bearing at the wheel end for which a higher sensor temperature has been ascertained is overheating or has overheated as a result of a fault.

14. The method of claim 13, wherein the fault consists in the bearing being damaged.

15. The method of claim 1, wherein the first wheel end and the second wheel end are located on a same vehicle axle of the vehicle or on different vehicle axles of the vehicle.

16. The method of claim 15, wherein the temperature deviation is formed between a first mean value and a second mean value, wherein:
the first mean value is formed from the first sensor temperature, which is measured at a first vehicle axle at the first wheel speed sensor by the first temperature sensor at the first wheel end, and from a further sensor temperature, which is likewise measured at the first vehicle axle at a further wheel speed sensor by a first further temperature sensor at a first further wheel end of the plurality of wheel ends; and,
the second mean value is formed from the second sensor temperature, which is measured at a second vehicle axle at the second wheel speed sensor by the second temperature sensor at the second wheel end, and from a second further sensor temperature, which is measured at the second vehicle axle at a further wheel speed sensor by a second further temperature sensor at a second of the plurality of wheel ends.

17. The method of claim 1, wherein the vehicle is a commercial vehicle.

18. An evaluation unit for a vehicle, the evaluation unit being configured to read from at least two wheel speed sensors, which are each arranged at different wheel ends of the vehicle and which each have a temperature sensor, a sensor temperature, which is measured in a sensing region, which encompasses at least the respective wheel speed sensor; the evaluation unit comprising:
a processor;
a non-transitory computer readable medium having program code stored thereon;
an input;
an output;
the evaluation unit being configured to read, via said input, a first sensor temperature measured by a first temperature sensor of a first wheel speed sensor at a first wheel end and to read, via said input, a second sensor temperature measured by a second temperature sensor of a second wheel speed sensor at a second wheel end;
said program code being configured, when executed by said processor, to determine a temperature deviation on a basis of the first sensor temperature and the second sensor temperature;
said program code being further configured, when executed by said processor, to compare the temperature deviation with a deviation limit value; and
the evaluation unit being configured to output, via said output, a notification at least one of when the deviation limit value is exceeded and if the two sensor temperatures deviate too widely from each other, wherein the notification includes that a temperature change induced by a fault has been detected at least at one of the wheel ends that have a wheel speed sensor having a temperature sensor.

19. A vehicle comprising:
a plurality of wheel ends, wherein at each wheel end a wheel is mounted rotatably;
said plurality of wheel ends including a first wheel end having a first wheel speed sensor for measuring a wheel speed of the associated wheel and a second wheel end having a second wheel speed sensor for measuring a wheel speed of the associated wheel
said first wheel speed sensor having a first temperature sensor configured to measure, around a position of said first temperature sensor, and to output a first sensor temperature in a first sensing region, which encompasses at least said first wheel speed sensor;
said second wheel speed sensor having a second temperature sensor configured to measure, around a position of said second temperature sensor, and to output a second sensor temperature in a second sensing region, which encompasses at least said second wheel speed sensor;
an evaluation unit configured to:
read the first sensor temperature measured by said first temperature sensor of said first wheel speed sensor at said first wheel end;
read the second sensor temperature measured by said second temperature sensor of said second wheel speed sensor at said second wheel end;
determine a temperature deviation on a basis of the first sensor temperature and the second sensor temperature;
compare the temperature deviation with a deviation limit value; and,
output a notification at least one of when the deviation limit value is exceeded and if the two sensor temperatures deviate too widely from each other, wherein the notification includes that a temperature change induced by a fault has been detected at least at one of said first wheel end and said second wheel end.

20. The vehicle of claim 19, wherein said evaluation unit is a component part of a brake control unit of a braking system of the vehicle.

21. The vehicle of claim 19, wherein the vehicle is a commercial vehicle.

22. The vehicle of claim 19, wherein said wheel speed sensors are actively driven.
